(19) United States
(12) Patent Application Publication
(10) Pub. No.: US 2012/0283148 A1
(43) Pub. Date: Nov. 8, 2012

(54) Methods and Compositions for Hydrocarbon-Based Crosslinking Additives with Non-Detectable BTEX Levels

(75) Inventor: James W. Dobson, JR., Houston, TX (US)

(73) Assignee: TEXAS UNITED CHEMICAL COMPANY, LLC, Houston, TX (US)

(21) Appl. No.: 13/464,593

(22) Filed: May 4, 2012

Related U.S. Application Data
(60) Provisional application No. 61/482,311, filed on May 4, 2011.

(51) Int. Cl. C09K 8/64; C09K 8/34

(52) U.S. Cl. 507/103; 507/203

(57) ABSTRACT

Disclosed is a hydrocarbon-based concentrate composition for crosslinking polysaccharide polymers in an aqueous-based fluid, such as a fracturing fluid, wherein the hydrocarbon-based composition has no or substantially no detectable levels of benzene, toluene, ethylbenzene, and/or m-, o-, or p-xylenes (BTEX). Preferred polysaccharide polymers are galactomannan gums or derivatives thereof. The concentrate comprises an oleaginous solution, such as a hydrocarbon distillate, a crosslinking agent for crosslinking the polysaccharide polymer, preferably a sparingly soluble alkali metal or alkali metal alkaline earth metal borate, and a stabilizing/suspension agent, preferably a clay mineral selected from the group consisting of smectite clays. The concentrate may, optionally, contain a deflocculant and/or an anti-syneresis additive.

### CROSS REFERENCE TO RELATED APPLICATIONS

This application claims priority to U.S. Provisional patent application Ser. No. 61/482,311, filed May 4, 2011, the contents of which are incorporated by reference in their entirety.

### STATEMENT REGARDING FEDERALLY SPONSORED RESEARCH OR DEVELOPMENT

Not applicable.

### REFERENCE TO APPENDIX

An appendix is attached to this provisional application, reference is which made hereto, and the contents of which are incorporated herein in their entirety.

### BACKGROUND OF THE INVENTION

1. Field of the Invention

The inventions disclosed and taught herein relate generally to water-based well drilling and servicing fluids (such as fracturing fluids). In particular, the invention relates to hydrocarbon-based fluidized suspensions containing crosslinking agents, wherein the fluids are characterized by a non-detectable levels of benzene, toluene, ethylbenzene, and xylene (BTEX).

2. Description of the Related Art

Benzene, toluene, ethylbenzene, and the xylene isomers, collectively referred to as BTEXs, are the most common aromatic compounds in petroleum (the amount of BTEX can be up to a few percent of the total weight for some crude oils) and are prevalent organic contaminants in ground water, soil, sediments, and aquifers. Of particular concern is benzene and the related alkyl-benzenes, as a result of its toxicity and carcinogenicity. The general public and government agency regulators have expressed increased concern for public health and safety and the potential harmful effects of toxic materials in the water and air. There are specific concerns on the negative effects of benzene, toluene, ethylbenzene, and the xylene isomers (p-, m-, and o-xylenes) as contaminants in groundwaters, soil, sediments, and aquifers.

The aromatic series of hydrocarbons (having the general chemical formula CₙH₂ₙ₋₆), often termed the benzene series, is known to be chemically active. The aromatics may form either addition or substitution products, depending upon the conditions of reaction and the reaction environment. Only a few types of petroleum contain more than a trace of the low-boiling aromatics such as benzene and toluene. The aromatic series of hydrocarbons is both chemically and physically very different from the paraffins and naphthenes found in petroleum and hydrocarbons recovered from many subsurface deposits. For example, it contains a benzene ring that is unsaturated but is very stable, and thus frequently behaves as a saturated compound. The C₆-C₈ aromatics (benzene, toluene, ethyl benzene and the m-, o-, and p-xylenes) are the largest volume aromatics used by the petrochemical industry, with the greatest demand being for benzene. The product from catalytic reforming contains all of these aromatics, and it is separated into its pure components by a combination of solvent extraction, distillation and crystallization.

In addition, because of the much greater demand for benzene, the excess of toluene and xylene over market needs can be converted to benzene by hydrodealkylation. Present separation methods for recovery of aromatics from hydrocarbon streams use liquid-liquid solvent extraction to separate the aromatic fraction from the other hydrocarbons; most of the processes used by U.S. refineries use either polyglycols or sulfolane as the extracting solvent. However, most of these processes do not remove all of the BTEX compounds form the hydrocarbon streams, and thus when such contaminated hydrocarbons are used in hydrocarbon-recovery processes, these contaminates are introduced into the environment. “BTEX” is the collective term used in the industry for the volatile organic compounds benzene, toluene, ethyl benzene, and xylenes (m-, o- and p-xylene, separately and inclusive, and is a constituent of gasoline and numerous other petroleum products. As discussed above, BTEX compounds are both volatile and relatively soluble in water. The Gas Research Institute (GRI) has reported the health hazards for the BTEX group, classifying toluene, ethyl benzene and xylene as irritants with narcotic effects. Benzene has all these effects, in addition to being a human carcinogen, making it toxic via inhalation or ingestion, such as by way of contaminated groundwater.

In an effort to address these BTEX contamination concerns and minimize the addition of such compounds to the groundwater, various threshold limits of the presence of BTEX contaminants have been established. The United States Environmental Protection Agency (EPA) has established National Primary Drinking Water Standards which are: (i) benzene—5 ppb (g/L); (ii) toluene—1,000 ppb (μg/L); (iii) ethylbenzene—700 ppb (μg/L); and, (iv) xylene—10,000 total ppb (μg/L). Other private and governmental organizations are actively establishing guidelines for these BTEX components. Exemplary threshold limits for BTEX contamination have been established by a number of sources, including the Chemical Abstract Services Registry service, the Queensland Public Health Regulation, the Australian Drinking Water Guidelines, the World Health Organization (WHO) Drinking Water guidelines, and the Australian and New Zealand Environment Conservation Council Environmental Protection Guidelines, and are shown in FIG. 1 (information based on data published by Leusch, F. and Bartkow, M., “A Short Primer on Benzene, Toluene, Ethylbenzene, and Xylenes (BTEX) in the Environment and in Hydraulic Fracturing Fluids,” Smart Water Research Centre, Nov. 17, 2010).

The inventions disclosed and taught herein are directed to hydrocarbon-based crosslinking additive compositions for use well treatment fluids and drilling fluids for use in hydrocarbon recovery, wherein the fluids can be prepared such that they exhibit substantially low or non-detectable levels of one or more, preferably all, of the aromatic contaminants benzene, toluene, ethylbenzene, and the xylene isomers (BTEX) in the fluids themselves so as to meet the increasingly stringent standards set for acceptable levels of these compounds within the environment, while still maintaining the utility of the oleaginous (hydrocarbon-based) crosslinking fluid additive compositions in the field in a cost-effective manner.

### BRIEF SUMMARY OF THE INVENTION

The objects described above and other advantages and features of the invention are incorporated in the application as set forth herein, and the associated appendices and drawings, related to methods, compositions, and systems for treating subterranean formations.

The novel feature of the present disclosure is that hydrocarbon-based crosslinking additive compositions can be prepared such that they exhibit substantially low or non-detectable levels of benzene, toluene, ethylbenzene, and xylene (including the m-, o-, and p-xylene isomers) so as to meet a variety of regulatory standards, as determined by, for example, EPA testing method SW 8260 or the equivalent.

In accordance with a first aspect of the present disclosure, a method of treating a subterranean formation is described, the method comprising providing a fluid comprising an oleaginous fluid, a suspending agent, a gelling agent, a surfactant, and a crosslinking agent, wherein at least one crosslink forms in the gelling agent; and introducing the fluid into a well bore that penetrates the subterranean formation, wherein the fluid has a non-detectable BTEX level as measured by gas chromatography/mass spectroscopy.

In accordance with a further aspect of the present disclosure, an oleaginous crosslinking fluid is described, wherein the fluid comprises an oleaginous liquid; a gelling agent; a crosslinking agent; and a suspending agent, wherein the crosslinking fluid has a non-detectable BTEX level as measured by gas chromatography/mass spectroscopy. In further accordance with this aspect of the disclosure, the fluid further comprises one or more of a deflocculant, a surfactant, and/or a syneresis additive.

In accordance with yet another aspect of the present disclosure, an oleaginous crosslinking fluid is described, wherein the fluid comprises an oleaginous liquid; a gelling agent; a crosslinking agent; and a suspending agent, wherein the fluid contains from about 0 ppb to less than 5 ppb of benzene, from about 0 ppb to less than 1,000 ppb of toluene, from about 0 ppb to less than 700 ppb of ethylbenzene, and from about 0 ppb to less than 10,000 ppb of xylene (total xylenes), as determined using EPA testing method SW 8260 or another, suitable testing method, such as a GC/MS-based testing method. In further accordance with this aspect of the disclosure, the fluid contains from about 0 ppb to less than 1 ppb of benzene, from about 0 ppb to less than 800 ppb of toluene, from about 0 ppb to less than 300 ppb of ethylbenzene, and from about 0 ppb to less than 600 ppb of xylene (total xylenes), as determined using EPA testing method SW 8260. In yet another embodiment of this aspect, the fluid contains from about 0 ppb to less than 1 ppb of benzene, from about 0 ppb to less than 700 ppb of toluene, from about 0 ppb to less than 300 ppb of ethylbenzene, and from about 0 ppb to less than 500 ppb of xylene (total xylenes), as determined using EPA testing method SW 8260.

In accordance with a further aspect of the present disclosure, a fluid for fracturing a subterranean formation is described, the fluid being prepared by a process comprising the steps of: (a) providing an aqueous drum of a hydrated polymeric gum, the gum being capable of complexing with a borate ion in the fluid; (b) adding thereto a crosslinking fluid comprising: (i) an oleaginous liquid; (ii) a gelling agent capable of complexing with a borate ion; (iii) a boron-containing crosslinking agent; and (iv) a suspending agent, wherein the crosslinking fluid has a non-detectable BTEX level as measured by gas chromatography/mass spectroscopy, and (c) pumping the aqueous mixture of the hydrated gum and the ingredients added in step (b) into a wellbore to the subterranean formation at fracturing pressures; (d) crosslinking the hydrated gum with borate ions released by the gelled complexes of boron, wherein each of the plurality of the complexes of boron releases at least one borate ion to effect cross-linking of the gum at the conditions of the subterranean formation, and wherein the subterranean formation has a temperature ranging from about 100° F. to greater than 200° F. In further accordance with this aspect of the disclosure, the fluid further comprises a proppant, a breaking agent, or both.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 provides a table showing exemplary water guidelines for benzene, toluene, ethylbenzene, and the xylene isomers (collectively, BTEX).

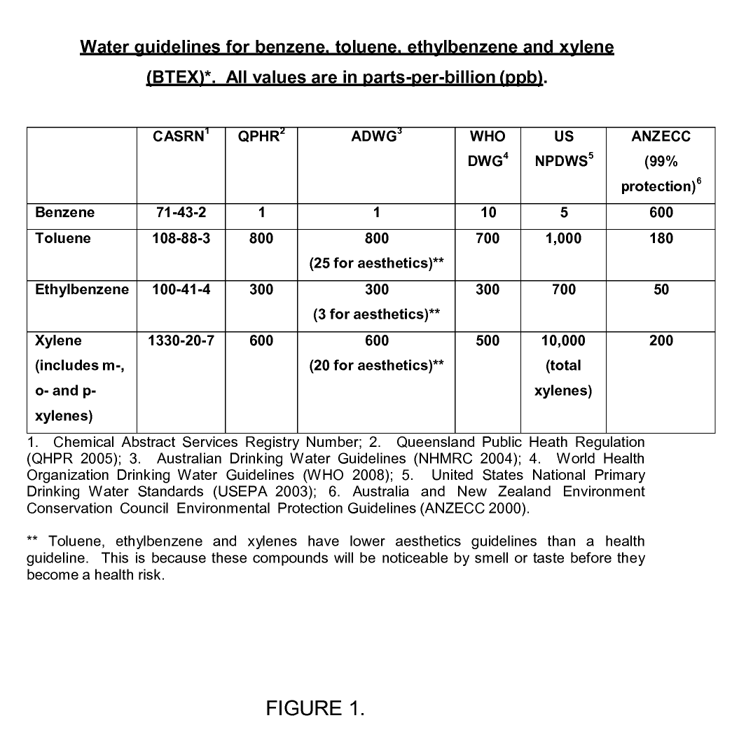

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created compositions that include a hydrocarbon-based crosslinking additive composition having low or non-detectable levels of BTEX, or BTEX and alkyl-substituted benzene components such as C₂- and C₃-benzenes (as determined using standardized testing protocols) in well treating fluids, and methods of formulating such compositions, as well as the use of such compositions in a variety of subterranean well treating operations.

The present disclosure also comprises a method of formulating and using an earth support fluid containing hydrocarbon-based crosslinking additives which exhibit low or non-detectable levels of BTEX, as measured using gas chromatography/mass spectroscopy analytical methods and/or established analytical standards. The methods may be used in a variety of subterranean hydrocarbon recovery operations, including fracturing and hydraulic fracturing operations, wherein an earth support fluid is used in vertical, angled, or horizontal boreholes.

In accordance with aspects of the present disclosure, the hydrocarbon-based crosslinking additives of the present disclosure having little to no detectable levels (as measured by GC/MS) of one or more, and preferably at least three aromatic contaminants selected from the group consisting of benzene, toluene, ethyl benzene, and the xylene isomers (collectively BTEX), comprise an oleaginous liquid, a suspending agent, a surfactant, and a boron-based crosslinking agent such as borax, boric acid or a sparingly-soluble borate, or combinations thereof, suspended in the oleaginous liquid. The additive crosslinking composition may also, optionally, contain a deflocculant and/or an anti-syneresis additive.

As used herein, the term “aromatic contaminants” includes the BTEXs, as well as aromatic alkylbenzene compounds or mixtures of such compounds wherein the alkyl group ranges from C₁ to C₇. Further, in accordance with aspects of this disclosure, the aromatic contaminants can also include BTEX+C₂-benzenes and/or BTEX+C₃-benzenes, and/or the C₁₀H₁₄ compound tert-butylbenzene. C₂-benzenes refers generally to the sum of all the C₈H₁₀ isomers (e.g., 1,2-dimethylbenzene, 1,3-dimethylbenzene, 1,4-dimethylbenzene, etc.), while the sum of all the C₉H₁₂ isomers represent the C₃-benzenes (e.g., 1,2,3-trimethylbenzene, n-propylbenzene, 4-ethyl toluene, 1,3,5-trimethylbenzene (1,3,5-TMB), 1,2,4-trimethylbenzene).

The oleaginous fluid of the present invention is a liquid and more preferably is a natural hydrocarbon-based or synthetic oil, and more preferably the oleaginous fluid is selected from the group including but not limited to oleaginous liquids having a high flash-point and/or a high boiling point. Boiling point refers to the temperature at which a substance changes state from a liquid to a gas, throughout the bulk of the liquid. The phrase “high boiling point” as used herein refers to oleaginous fluids, especially petroleum distillates boiling between about 50° C. and about 370° C., inclusive, more preferably petroleum distillates that boil between about 70° C. and about 200° C., inclusive. Flash point refers to the potential of a volatile material to cause fires, e.g., the lowest temperature at which the material can vaporize to form an ignitable mixture in air. A high flash point of the oleaginous fluids suitable for use in the compositions of the present invention is important primarily from a fuel-handling standpoint, as when the flash point is too low, the fuel can be considered to be a fire hazard, subject to flashing, and possible continued ignition and explosion. In addition, a low flash point can be an indicator of contamination by more volatile and explosive fuels, such as gasoline.

An oleaginous fluid for preparing compositions of the invention typically has a high flash point, referring to a flash point ranging from about 70° C. (158° F.) to about 300° C. (572° F.), inclusive, and preferably from about 75° C. (167° F.) to about 225° C. (437° F.), inclusive.

Methods to measure flash point are well known. For example, ASTM D-92 and D-93 provide procedures for determining the flash point of a solvent. The current address for ASTM is 100 Barr Harbor Drive, West Conshohocken Pa. 19428-2959. ASTM D92-90 (i.e., test D92, last revised in 1990) as set forth in the Annual Book of ASTM Standards, Section 5 (pages 28-32 in 1996 edition), is directed to a test method for measuring flash and fire points by the so-called Cleveland Open Cup method. The Cleveland Open Cup method is particularly suited for measuring the flash points of viscous materials having a flash point of 79° C. and above, i.e., liquids with relatively high flash points such as mineral oils. ASTM D93-94 as set forth in the Annual Book of ASTM Standards, Section 5 (pages 33-46 is 1996 edition), is directed to a test method for measuring flash-point by the Pensky-Martens Closed Cup Tester. The Pensky-Martens Closed Cup Tester may be used with fuel oils, lubricating oils, and other homogeneous liquids.

While flash point may be measured by the above-listed techniques, in addition, many reference books and catalogs provide flash point information about solvents and fuels. For example, the Aldrich Chemical Company (Milwaukee, Wis.) offers a catalog of over a thousand chemicals, and in this catalog the flash points of many of the available chemicals is set forth. The Material Data Safety Sheet (MSDS) that is often available from a chemical manufacturer, typically provides flash point information about the chemical.

In accordance with one aspect of the present disclosure, the oleaginous fluid is a hydrocarbon oil selected from the group selected from the group consisting of any high boiling point, and/or high flash point hydrocarbon oils that are substantially non-water soluble. Preferred for environmental reasons are hydrocarbon oils which contain a very low concentration of aromatic hydrocarbons, such as about 0.1% by weight maximum aromatic hydrocarbons, and preferably 0 wt. % aromatic hydrocarbons. Preferably, the substantially non-water soluble organic oil is a hydrocarbon selected from the group consisting of alkanes (e.g., paraffins, isoparaffins) having the general molecular formula CₙH₂ₙ₊₂, alkenes (e.g., olefins, alpha olefins, polyalphaolefins) having the general molecular formula CₙH₂ₙ, various petroleum fractions such as mineral oils, white oils and the like, including vegetable oils such as canola oil, grape seed oil, rape seed oil, and the like, and hydrotreated oils. Most preferably, in accordance with the present disclosure, the hydrocarbon oil is a hydrogenated or “hydrotreated” oil whose composition is comprised of saturated hydrocarbons (e.g., paraffins) of medium and high molecular weight, but does not include diesels, kerosene, and/or lubricating oils. As used herein, the term “hydrotreated” refers to oleaginous fluids (especially hydrocarbons) obtained by processes wherein a hydrogen-containing feed gas is used in the presence of a suitable catalyst that is primarily active for the removal of heteroatoms, such as sulfur and nitrogen. Hydrotreated light distillates of petroleum, in accordance with the present disclosure, are typically mixtures of highly-refined hydrocarbon distillates in the C₉-C₁₆ range, particularly a mixture of aliphatic (saturated or unsaturated) and/or alicyclic hydrocarbons with little to no hydrocarbons (0.1 wt. % maximum, thus “essentially aromatic hydrocarbon free”). In one embodiment, the amount of oleaginous fluid used in the compositions ranges from about 30% to about 95% by volume (weight percent, wt %) and more preferably ranges from about 40% to about 90% by volume of the crosslinking additive composition.

The suspending agent useful in the cross-linking, low viscosity compositions of the disclosure are preferably clays, particularly organophillic clays. Exemplary clay suspending agents suitable for use in accordance with the present disclosure include palygorskite clays (magnesium aluminum phyllosilicates) such as sepiolite, attapulgite, and the like, or smectite clays such as hectorite, montmorillonite, saponite, bentonite, and the like. Various combinations of these suspending agents may be utilized in the compositions of this disclosure.

The concentration of the clay suspending agent in the compositions of the present disclosure is from about 1 to about 15 pounds per 42 gallon barrel of the concentrates, preferably from 2 to about 12 pounds per 42 gallon barrel of the concentrate. Alternatively, and equally acceptable, the suspending agent may be present in an amount ranging from about 0.1 wt. % to about 15 wt. % of the composition, inclusive, more preferably from about 0.5 wt. % to about 4 wt. % of the composition.

The preferred concentrates may also contain a deflocculating agent (deflocculant). The deflocculant decreases the viscosity and/or the gel strength of the concentrate, thus enhancing the pourability of the concentrates and/or allowing more suspending agents to be incorporated into the concentrates. Any number of known deflocculants, alone or in combination, may be used with the compositions of the present disclosure, provided that they do not change the overall characteristics of the compositions described herein. Known deflocculants effective in saline fluids are various synthetic polymers, copolymers, or telomers. Generally these deflocculants will contain at least one monomer which contains an anionic functional group, such as a carboxylic acid or sulfonic acid group. See for example, U.S. Pat. No. 7,018,956 and the patents referenced therein. Thus, U.S. Pat. No. 3,730,900 discloses various low molecular weight copolymers of styrene sulfonic acid and maleic anhydride and water soluble salts thereof. U.S. Pat. No. 3,764,530 discloses certain low molecular weight non-halogen-containing acrylic acid polymers and water soluble salts thereof. U.S. Pat. No. 4,680,128 discloses certain copolymers of acrylic acid and vinylsulfonic acid, and alkali metal salts thereof. U.S. Pat. No. 5,026,490 discloses certain low molecular weight polymers composed of styrene sulfonate (sodium salt) monomer, maleic anhydride (either as the anhydride or the diacid), and a zwitterionic functionalized maleic anhydride. U.S. Pat. No. 5,287,929 discloses copolymers of a first monomer and a second monomer, wherein the first monomer is maleic anhydride, maleic acid, acrylic acid, or methacrylic acid and the second monomer is sulfonated ethene, sulfonated propene, sulfonated 1-butene, sulfonated 2-butene, sulfonated 1-pentene, sulfonated 2-pentene, sulfonated 2-methyl-1-butene, sulfonated 2-methyl-2-butene, sulfonated 3-methyl-1-butene, sulfonated cyclopentene, sulfonated cyclohexene, sulfonated 1-hexene, sulfonated 2-hexene, sulfonated 3-hexene, sulfonated 2-methyl-1-pentene, sulfonated 2-methyl-2-pentene, sulfonated 2-methyl-3-pentene, sulfonated 3-methyl-1-pentene, sulfonated 3-methyl-2-pentene, sulfonated 4-methyl-1-pentene, sulfonated 3,3-dimethyl-1-butene, sulfonated 2,3-dimethyl-1-butene, sulfonated 2,3-dimethyl-2-butene, sulfonated 2-ethyl-1-butene, sulfonated 1,3-butadiene, sulfonated 1,3-pentadiene, sulfonated 1,4-pentadiene, sulfonated 2-methyl-1,3-butadiene, sulfonated 2,3-dimethyl-1,3-butadiene, sulfonated 2-ethyl-butadiene, sulfonated 2-methyl-1,3-pentadiene, sulfonated 3-methyl-1,3-pentadiene, sulfonated 4-methyl-1,3-pentadiene, sulfonated 2-methyl-1,4-pentadiene, sulfonated 3-methyl-1,4-pentadiene, sulfonated 4-methyl-1,4-pentadiene, sulfonated 1,3-hexadiene, sulfonated 1,4-hexadiene, sulfonated 1,5-hexadiene, sulfonated 2,4-hexadiene, or sulfonated 1,3,5-hexatriene. The sulfonate and carboxylate groups on the copolymers may be present in neutralized form as alkali metal or ammonium salts.

The crosslinking agent suitable for use in the compositions of the present disclosure may be any of the known crosslinking compounds known in the art, preferrably boron-releasing crosslinking compounds, such as borax, boric acid, sparingly-soluble borates, or combinations thereof, the requirement being only that the crosslinking agent selected generally comprises at least one ion that is capable of crosslinking at least two gelling agent molecules. Most particularly preferred are the sparingly-water-soluble (or slightly-water soluble) borates set forth in U.S. Pat. No. 4,619,776, incorporated herein by reference. Sparingly- or slightly-soluble refers to the solubility of 1.00 gram of borate sample in 100 mL of distilled water at 22° C. (71.6° F.), and is typically on the order of less than about 10 kg/m³, as may be determined using procedures known in the arts such as those described by Guilensoy, et al. [M. T. A. Bull., no. 86, pp. 77-94 (1976); M.T.A. Bull., no. 87, pp. 36-47 (1978)]. Example, non-limiting solubility's range from about 0.1 kg/m³ to about 5 kg/m³, inclusive. These slightly water soluble borates are included in the cross-linking compositions to act as time delayed cross-linking agents in gelled, aqueous well treating fluids. Such sparingly-soluble, or slightly-soluble borates have at least five boron atoms per molecule and are selected from the group consisting of alkaline earth metal borates, alkali metal-alkaline earth metal borates, such as ulexite and colemanite, and mixtures thereof. Examples of such borates are probertite (NaCaB₅O₉-5H₂O), ulexite (NaCaB₅O₉-8H₂O), nobleite (CaB₆O₁₀-4H₂O), frolovite (Ca₂B₄O₈-7H₂O), colemanite (Ca₂B₆O₁₁-5H₂O), calcined colemanite (Ca₂B₆O₁₁—H₂O), priceite (Ca₄B₁₀O₁₉-7H₂O), pateronite (MgB₈O₁₃-4H₂O), hydroboracite (CaMgB₆O₁₁-6H₂O), kaliborite (KMg₂B₁₁O₁₉-9H₂O) and other similar borates. Of the various slightly water soluble/sparingly-soluble borates which can be used, colemanite, calcined colemanite, and ulexite are preferred with ulexite being the most preferred.

The concentration of the crosslinking agent in the concentrates of the invention generally is in the range from about 100 pounds per 42 gallon barrel of the concentrate to about 250 pounds per 42 gallon barrel of the concentrate, preferably from about 150 to about 200 pounds per 42 gallon barrel of the concentrate. Alternatively, the crosslinking agent is present in the concentrate from about 15% by weight (wt. %) of the composition to about 85% by weight, (wt. %) preferably from about 30% to about 60% by weight of the composition.

The crosslinking agent is maintained suspended in the concentrate by incorporating an organophilic clay suspending agent therein. The suspending agent increases the viscosity of the concentrate and prevents the settling of the crosslinking agent. Preferred suspending agents also minimize syneresis, the separation of the liquid medium, i.e., the base hydrocarbon, to form a layer on top of the concentrate after aging.

The suspending agent may be any well-known, commercially available viscosifier/suspension additive for organic liquids. Suitable organophilic clays are palygorskite clay such as sepiolite, attapulgite, and the like, smectite clay such as hectorite, montmorillonite, saponite, bentonite, and the like, as well as the reaction products of smectite-type clays and cations, i.e., quaternary ammonium cations. See, for example Dino, et. al., U.S. Pat. No. 6,187,719, incorporated herein by reference. In accordance with one aspect of the present disclosure, the preferred smectite-type clay suitable for use with the compositions described herein is selected from the group consisting of bentonite, hectorite, montmorillonite, biedellite, saponite, stevensite, and mixtures thereof, most preferably bentonite.

The fluid compositions of the present invention may also include one or more surfactants. Surfactants can be added for a variety of reasons, such as to reduce surface tension within the rock matrix, control wettability, generate foam to assist in removing the particulate products of drilling, or for other purposes. The fluid crosslinking compositions described herein may optionally include one or more surfactants that function to disperse one or more liquid, solid, or gaseous components. The surfactant may be ionic (e.g., anionic, cationic, or amphiphilic), or nonionic. Without limitation, suitable surfactants for use herein include those surfactants described in U.S. Pat. No. 7,150,322 (Szymanski, et al., issued Dec. 19, 2006), U.S. Pat. No. 5,566,760 (Harris, issued Oct. 22, 1996), and U.S. Pat. No. 6,966,379 (Chatterji, et al, issued Nov. 22, 2005). The surfactant may be a soap-like molecules containing a long hydrophobic paraffin chain with a hydrophilic end group. Surfactants include cationic, anionic, nonionic or amphoteric compounds such as for example, betaines, sulfated or sulfonated alkoxylates, alkyl quarternary amines, alkoxylated linear alcohols, alkyl sulfonates, alkyl aryl sulfonates, C₁₀-C₂₀ alkyldiphenyl ether sulfonates, and the like, and any combination thereof. Examples of suitable surfactants include polyethylene glycols, ethers of alkylated phenol, sodium dodecylsulfate, alpha olefin sulfonates such as sodium dodecane sulfonate and trimethyl hexadecyl ammonium bromide. The surfactant may include or consist of one or more nonionic surfactant. Preferred nonionic surfactants have a generally low hydrophile-lipophile balance (“HLB”) values. Commercially available nonionic surfactants include, but are not limited to, ENVIROGEM™ AE01, ENVIROGEM™ AE02, and ENVIROGEM™ AE03 available from Air Products and Chemicals, Inc., of Allentown, Pa., and RHODOCLEAN™ HP, available from Rhodia Inc. of Cranbury, N.J. The surfactant may include a tertiary alkyl amine ethoxylates. Nonlimiting examples of amphoteric surfactants that may be used include lauryl amine oxide, a mixture of lauryl amine oxide and myristylamine oxide, cocoamine oxide, lauryl betaine, oleyl betaine, cocoamido propyl betaine, or combinations thereof. Other suitable, exemplary surfactants for use herein include those surfactants available from Conlen Surfactant Technology, Conroe, Tex. (USA). The amount of surfactant used, when included, can range from about 1 wt. % to about 5 wt. %, inclusive, including from about 2.0 wt. % to about 3.0 wt. %, inclusive.

The concentrates of the invention can contain an anti-syneresis agent. Concentrates of suspended solids are known to “bleed” clear liquid on aging, a process known as ‘syneresis’, whereby liquid separates from the concentrate due to contraction of the solid/liquid mixture. The crosslinking compositions of the present invention preferably exhibit a maximum syneresis of 15% by volume on static aging the concentrates for sixteen hours at 120° F. (48.9° C.).

Representative anti-syneresis agents (anti-settling agents) are colloidal silicas and hydrophobic, surface modified silicas, preferably fumed silicas, and synthetic water soluble polymers which generally provide viscosity to salt-free aqueous fluids but which do not appreciably enhance the viscosity of the formate brines used in the inventive concentrates.

Exemplary colloidal silicas suitable for use herein are set forth in Dobson, Jr. et al. U.S. Pat. No. 5,728,652. Preferred colloidal silicas are the pyrogenic, fumed silicas. Preferred silicas have an ultimate particle size less than about 100 millimicrons. The silica particles may be loosely aggregated to about a 0.5 to 5 micron size, but when mixed into a liquid deaggregate to less than 100 millimicron sized particles. The concentration of the optional silica anti-syneresis agent in the concentrates of the invention is from 0 to about two pounds per 42 gallon barrel of the concentrate, preferably from about 0.25 to about one pound per 42 gallon barrel of the concentrate.

In accordance with further aspects of the present disclosure, the fluids described herein may also include one or more buffers with the resulting fluid in order to adjust and/or maintain the pH at a desired level for crosslinking and/or hydration of the gelling agent, and then combining the crosslinking agent with the resulting, pH-controlled fluid.

The preferred concentrates of the invention preferably are pourable upon gentle agitation) such as shaking or rolling the container containing the concentrate, or low shear mixing in large containers, i.e., the gels must be fragile if the composition gels. Concentrates which do not gel are, of course, pourable and exemplary of the concentrates of the invention.

Individuals skilled in the art, with the benefit of this disclosure, will recognize that additional additives may be included in the treatment fluids of the present invention as desired for a particular application. Such additives may include, but are not limited to, accelerants, proppant particulates, clay control agents, corrosion inhibitors, friction reducers, gel stabilizers, fluid loss control additives, bactericides, and surfactants, and combinations thereof. Suitable clay control agents for use in the instant compositions include, but are not limited to, potassium chloride, sodium chloride, and tetramethyl ammonium chloride, combinations thereof, and derivatives thereof.

As indicated above, a novel feature of the present disclosure is that well treatment fluids containing hydrocarbon-based crosslinking additive compositions can be prepared such that they (both the treatment fluid and the crosslinking additive compositions) exhibit substantially low or non-detectable levels of contaminant hydrocarbons, especially one or more, and preferably at least three aromatic contaminant hydrocarbons selected from the group consisting of benzene, toluene, ethylbenzene, and the xylene isomers (p-, m- and o-xylenes), as well as alkyl-substituted benzene contaminants, as determined using an appropriate, approved testing method, such as the EPA S.W. 8260B (entitled “Volatile Organic Compounds by Gas Chromatography/Mass Spectrometry (GC/MS)”), S.W. 8015B, 5030B, and/or the S.W. 846 (entitled “Test Methods for Evaluating Solid Waste, Physical/Chemical Methods”) testing methods, other gas chromatography/mass spectroscopy based testing methods, or the equivalent.

Additional analytical testing techniques may also be used for the determination of the BTEX levels, singly or in combination with the methods referenced above, including but not limited to flame ionization detection (FID), ultra-violet (UV) absorption, and Fourier transform Infra-Red spectroscopy (FTIR). Preferably, in accordance with the present disclosure, the hydrocarbon-based crosslinking additive composition exhibits a benzene level from about 0 ppb to less than 600 parts-per-billion (ppb, where 1 ppb=1 g/L), a toluene level less than 1,000 ppb, an ethylbenzene level less than 700 ppb, and a xylene level of less than 10,000 ppb (total xylenes, which is a combination of the m-, o- and p-xylene isomers); more preferably, the hydrocarbon-based crosslinking additive compositions described herein exhibit a benzene level from about 0 ppb to less than 10 parts-per-billion (ppb), a toluene level less than 700 ppb, an ethylbenzene level less than 300 ppb, and a xylene level of less than 500 ppb (total xylenes, which is a combination of the m-, o- and p-xylene isomers); even more preferably, the hydrocarbon-based crosslinking additive compositions described herein exhibit a benzene level from about 0 ppb to less than 5 parts-per-billion (ppb), a toluene level less than 150 ppb, an ethylbenzene level less than 50 ppb, and a xylene level of less than 200 ppb (total xylenes, which is a combination of the m-, o- and p-xylene isomers), as determined by one or more of the testing methods referenced above. In accordance with a further aspect of the present disclosure, the hydrocarbon-based crosslinking additive compositions described herein exhibit a benzene level from about 0 ppb to less than 1 parts-per-billion (ppb), a toluene level less than 10 ppb, an ethylbenzene level less than 50 ppb, and a xylene level of less than 50 ppb (total xylenes, which is a combination of the m-, o- and p-xylene isomers).

In typical application, borate cross-linking composition of this invention, having non-detectable levels of one or more BTEX contaminants, is added to a galactomannan gelled aqueous well treating fluid as a single liquid component. The composition controls the pH of the treating fluid at a level whereby the delayed borate therein effectively cross-links the hydrated galactomannan gelling agent in a desired time period, e.g., from about 1 to about 120 minutes as determined by the vortex closure time. The vortex closure time is determined by adding 250 ml of a specified gelled fluid to a 500 ml blender jar or a Waring blender at room temperature. The speed of the blender is adjusted so that the base of the vortex created in the fluid within the jar is at the top of the retaining nut for the blade assembly, while air entrainment is minimized. The desired quantity of cross-linking composition is then added to the jar and the time for vortex closure is measured from the time of cross-linker addition.

The water utilized to form the improved cross-linked well treating fluids can be fresh water, salt water, brine or any other aqueous liquid which does not adversely react with other components of the treating fluids. The water normally contains one or more salts for inhibiting the swelling of clays in the subterranean formations or zones being treated or to add weight to the treating fluid. The most common clay inhibiting salt utilized is potassium chloride (KCl), but other salts, such as NaCl, NaBr, KBr, and the like can also be used. The pH of the water is preferably in the range of from about 6 to about 8.5 to facilitate the hydration of the galactomannan gelling agent utilized, but may be adjusted up or down in pH depending upon the requirements of the subterranean formation being treated.

The gelling agents suitable for use herein may be one or more material that can be gelled, cross-linked, or both. It may be one or more organic material. The gelling agent may be or include one or more oligomers, one or more polymer, or both. It may be synthetic, naturally occurring, or both. Without being bound by theory, when used in fracturing fluid compositions for well treatment, the gelling agent may function to keep a fracture in the subterranean formation open so that a proppant can penetrate into the fracture and/or further propagate the fracture. Exemplary gelling agents which can be used in accordance with the present invention include galactomannan gelling agents, including the naturally occurring gums and their derivatives such as guar, locust bean, tara, honey locust, tamarind, karaya, tragacanth, carrageenan and the like. These gums are generally characterized as containing a linear back bone consisting of mannose units having various amounts of galactose units attached thereto. The gums can be manufactured to contain one or more functional groups such as cis-hydroxyl, hydroxyl, carboxyl, sulfate, sulfonate, amino or amide. Of the various galactomannan gelling agents which can be utilized, one or more gelling agents selected from the group of guar, hydroxyethylguar, hydroxypropylguar, carboxymethylguar, carboxymethylhydroxyethylguar and carboxymethylhydroxypropylguar are preferred. Of these, guar is the most preferred. When one or more of the above mentioned galactomannan gelling agents are dissolved in the water used, the gelling agents are hydrated and a viscous aqueous gel is formed. In accordance with this invention, the galactomannan gelling agent or agents utilized are dissolved in the water in an amount in the range of from 0.05% to about 1% by weight of the water in the fluid, preferably in an amount of about 0.3% to about 0.75% by weight of the water in the fluid.

The amount of the crosslinking composition having non-detectable BTEX and/or alkyl-benzene substituted components in a well treating fluid can range from about 0.1 gallon per 1,000 gallons of water in the well treating fluid to about 15 gallons per 1,000 gallons of water in the well treating fluid, when water is used as the base fluid of the well treating fluid.

The well treating fluids suitable for inclusion of the crosslinking compositions of the instant disclosure include well servicing fluids, such as fracturing fluids (hydraulic and non-hydraulic), and gravel packing fluids, the well treating fluids comprising an aqueous liquid, a polysaccharide crosslinkable polymer hydrated or hydratable therein, and the crosslinking composition having non-detectable BTEX components of this invention.

In typical operation, a liquid, substantially aromatic hydrocarbon contaminant-free (e.g., no detectable BTEX components) borate cross-linking composition of this invention as described above is combined with an aqueous gelled treating fluid for buffering the treating fluid and cross-linking the polysaccharide crosslinkable polymer gelling agent in the treating fluid. Generally, the buffering and cross-linking borate composition is combined with the treating fluid in an amount in the range of from about 0.05% to about 6.0% by weight of water in the treating fluid, preferably in an amount ranging from about 0.1 wt. % to about 3.0 wt. %, inclusive.

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Preparation of a Low-BTEX Crosslinking Additive

A hydrotreated light distillate (229.0 mL; 46.23 wt. %; LVT®-200, available from Calumet Specialty Products Partners, L.P., Indianapolis, Ind.) is added to an appropriate mixing vessel, and 9.0 g (2.20 wt. %) of Claytone IMG-400 (available from Southern Clay Products, Gonzales, Tex.) is added while mixing. Propylene carbonate (1.0 mL; 0.29 wt. %) is then added, followed by 9.0 mL (2.25 wt %) of CST-7605D (available from Conlen Surfactant Technology, Conroe, Tex.) and dried ulexite (200.2 g.; 49.02 wt. %; obtained from the Bigadic region of Turkey, and having a D-50 of about 11 microns). The mixture is stirred until admixture is complete, and the solution is tested for BTEX levels using Method 8260B EPA, a gas chromatography/mass spectrometry (GC/MS) technique) to determine volatile organic compounds in the composition matrix (Table B). The BTEX levels for the individual oil and surfactant components are presented in Table C, below.

TABLE B
Comparison of BTEX values in diesel base suspensions versus low
aromatic content hydrocarbon suspensions.

| | | | | Test Results | |
|---|---|---|---|---|---|
| Aromatic | | Detection | Reporting | | Low |
| Volatile | Test | Limit, | Limit, | | Aro- |
| Organics | Method¹ | ppb² | ppm³ | Diesel | matic |
| Benzene | S.W. 8260 | 1 | 0.010 | 21,070 | BDL⁴ |
| Toluene | S.W. 8260 | 1 | 0.010 | 393,080 | BDL |
| Ethylbenzene | S.W. 8260 | 1 | 0.010 | 511,600 | BDL |
| Xylene | S.W. 8260 | 1 | 0.010 | 2,333,470 | BDL |

¹Testing conducted at Precision Petroleum Labs, Inc., Houston, Texas, USA.
²ppb = parts-per-billion, where 1 ppb = 1 μg/L.
³ppm = parts-per-million, where 1 ppm = 1 mg/L.
⁴BDL = below detection limit.

TABLE C
BTEX values of oil and surfactant components in low aromatic
content suspensions.

| Aromatic | | | Reporting | Test Results | |
|---|---|---|---|---|---|
| Volatile | Test | Detection | Limit, | LVT ®- | CST- |
| Organics | Method¹ | Limit, ppb² | ppm³ | 200⁴ | 7605D⁵ |
| Benzene | S.W. 8260 | 1 | 0.010 | BDL⁶ | BDL |
| Toluene | S.W. 8260 | 1 | 0.010 | BDL | BDL |
| Ethyl- | S.W. 8260 | 1 | 0.010 | BDL | BDL |
| benzene | | | | | |
| Xylene | S.W. 8260 | 1 | 0.010 | BDL | BDL |

¹Testing conducted at Precision Petroleum Labs, Inc. Houston, Texas, USA.
²ppb = parts-per-billion, where 1 ppb = 1 μg/L.
³ppm = parts-per-million, where 1 ppm = 1 mg/L.
⁴LVT ®-200 = hydrotreated light distillate available from Calumet Specialty Products.
⁵CST-7605D = a surfactant available from Conlen Surfactant Technology.
⁶BDL = below detection limit.

Other and further embodiments utilizing one or more aspects of the inventions described above can be devised without departing from the spirit of Applicant's invention. For example, operation specific additives can be included within the compositions described herein, depending upon the specifics of the production operation and the specific formation type, provided that the BTEX levels are not affected by the addition of such operation-specific additives (i.e., the detectable BTEX levels are not raised, and remain low or non-detectable), thereby making the system highly customizable. Further, the various methods and embodiments of the methods of manufacture and assembly of the system, as well as location specifications, can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

1. (canceled)

2. An oleaginous-based crosslinking fluid, the fluid comprising:
a high flash point oleaginous liquid that is substantially free of aromatic-containing hydrocarbon contaminants;
a crosslinking agent; and
a suspending agent,
wherein the crosslinking fluid has a non-detectable BTEX level as measured by gas chromatography/mass spectroscopy.

3. The oleaginous fluid of claim 2, further comprising one or more of a deflocculant, a surfactant, and/or an anti-syneresis additive.

4. An oleaginous crosslinking fluid, the fluid comprising:
an oleaginous liquid that is a hydrotreated hydrocarbon;
a boron-containing crosslinking agent; and
a suspending agent,
wherein the crosslinking fluid contains from about 0 ppb to less than 5 ppb of benzene, from about 0 ppb to less than 1,000 ppb of toluene, from about 0 ppb to less than 700 ppb of ethylbenzene, and from about 0 ppb to less than 10,000 ppb of xylene (total xylenes, including m-, p-, and o-xylene), and from about 0 ppb to less than 1,000 ppb of alkyl-substituted benzene components, including C₂- and C₃-benzenes, as determined using EPA testing method SW 8260.

5. The fluid of claim 4, wherein the fluid contains from about 0 ppb to less than 1 ppb of benzene, from about 0 ppb to less than 800 ppb of toluene, from about 0 ppb to less than 300 ppb of ethylbenzene, and from about 0 ppb to less than 600 ppb of xylene (total xylenes), as determined using EPA testing method SW 8260.

6. The fluid of claim 5, wherein the fluid contains:
from about 0 ppb to less than 1 ppb of benzene,
from about 0 ppb to less than 700 ppb of toluene,
from about 0 ppb to less than 300 ppb of ethylbenzene, and
from about 0 ppb to less than 500 ppb of xylene (total xylenes), as determined using EPA testing method SW 8260.

7. The fluid of claim 4, wherein the fluid tested in accordance with EPA testing method SW 8260 exhibits non-detectable levels of one or more of benzene, toluene, ethylbenzene, and/or xylene (total xylenes).

8. The fluid of claim 5, further comprising one or more of a deflocculant, a surfactant, and/or an anti-syneresis additive.

9. The fluid of claim 4, wherein the suspending agent is a clay or phyllosilicate material.

10. The fluid of claim 9, wherein the clay is a palygorskite clay selected from the group consisting of sepiolite, attapulgite, tuperssuatsiaite, yofortierite, and kalifersite.

11. The fluid of claim 9, wherein the clay is a smectite clay such as hectorite, montmorillonite, saponite, bentonite, beidellite, nontronite, volkonskoite, swinefordite, almbosite, kurumsakite, and yakhontovite.

12. The fluid of claim 4, wherein the crosslinking agent is a boron-containing compound capable of releasing at least one borate ion per molecule of the compound in solution.

13. The fluid of claim 12, wherein the boron-containing crosslinking agent is boric acid, boric oxide, alkali metal borate, alkaline earth metal borate, organoborate, or a mixture thereof.

14. The fluid of claim 12, wherein the boron-containing crosslinking agent is probertite, ulexite, nobleite, growerite, frolovite, colemanite, meyerhofferite, inyoite, priceite, tertschite, ginorite, pinnoite, paternoite, kurnakovite, inderite, preobrazhenskite, hydroboracite, inderborite, kaliborite, or veatchite.

15. The fluid of claim 12, wherein the crosslinking fluid is present in the fluid in an amount ranging from about 50 pounds per 42 gallon barrel of the fluid to about 250 pounds per 42 gallon barrel of the fluid.

16. A fluid for fracturing a subterranean formation, the fluid being prepared by the process comprising the steps of:
(a) providing an aqueous drum of a hydrated polymeric gum, the gum being capable of complexing with a borate ion in the fluid;
(b) adding thereto a crosslinking fluid comprising:
(i) an oleaginous liquid;
(ii) a gelling agent capable of complexing with a borate ion;
(iii) a boron-containing crosslinking agent; and
(iv) a suspending agent,
wherein the crosslinking fluid has a non-detectable BTEX level as measured by gas chromatography/mass spectroscopy, and
(c) pumping the aqueous mixture of the hydrated gum and the ingredients added in step (b) into a wellbore to the subterranean formation at fracturing pressures;
(d) crosslinking the hydrated gum with borate ions released by the gelled complexes of boron, wherein each of the plurality of the complexes of boron releases at least one borate ion to effect cross-linking of the gum at the conditions of the subterranean formation, and wherein the subterranean formation has a temperature ranging from about 100° F. to greater than 200° F.

17. The fluid of claim 16, wherein the fluid further comprises a proppant.

18. The fluid of claim 16, wherein the fluid further comprises a breaking agent.

19. (canceled)

20. (canceled)

21. A stable, liquid borate composition for cross-linking aqueous galactomannan gelled well treating fluids, the borate composition comprising:
a high flash point hydrocarbon liquid having from 9 to 16 carbons (C₉-C₁₆);
an organophillic clay;
a slightly water-soluble borate; and
a surfactant
wherein the liquid borate composition contains from about 0 ppb to less than 5 ppb of benzene, from about 0 ppb to less than 1,000 ppb of toluene, from about 0 ppb to less than 700 ppb of ethylbenzene, and from about 0 ppb to less than 10,000 ppb of xylene (total xylenes, including m-, p-, and o-xylene), and from about 0 ppb to less than 1,000 ppb of alkyl-substituted benzene components, including C₂- and C₃-benzenes, as determined using EPA testing method SW 8260 or using GC/MS analysis.
